(19) United States
(12) Patent Application Publication
(10) Pub. No.: US 2010/0300056 A1
(43) Pub. Date: Dec. 2, 2010

(54) Lawn grooming device

(75) Inventor: Steven A. Sprinkmann, Germantown, WI (US)

Correspondence Address: WELLS ST. JOHN P.S., 601 W. FIRST AVENUE, SUITE 1300, SPOKANE, WA, 99201, US

(73) Assignee: S & B Lawn Systems, Inc.

(21) Appl. No.: 12/454,938

(22) Filed: May 26, 2009

(51) Int. Cl. A01D 34/00

(52) U.S. Cl. 56/17.4

(57) ABSTRACT

A lawn grooming device is described and which includes a tow bar coupled to an overland vehicle; a drawbar support frame mounted on the tow bar; a first weighted earth engaging roller assembly affixed to the drawbar support frame; a drawbar mounted on the drawbar support frame; a flexible coupling mounted on the drawbar and which is resiliently moveable in either the horizontal or vertical directions; and a second weighted earth engaging roller assembly mounted on the coupling and disposed in trailing relation relative to the first weighted earth engaging roller assembly.

### TECHNICAL FIELD

The present invention relates to a lawn grooming device, and more specifically to a lawn grooming device which is coupled to, and trails behind, a lawn tractor of conventional design.

### BACKGROUND OF THE INVENTION

Lawn grooming devices that aesthetically alter the appearance of mowed grass are popular in many applications. The Office's attention is directed to my co-pending U.S. patent application Ser. No. 12/082,590 which was filed on Apr. 11, 2008, the contents of which are incorporated by reference herein. Lawn stripers of various designs have been utilized, heretofore, for grooming sports fields, golf greens, ornamental gardens, etc. As discussed in many earlier patents, most lawn stripers are fabricated, and then incorporated into the structure of large riding lawn mowers and/or are made for specific models of mowers. Even the previous devices that have been commercially sold, and which are useful for various mower applications, are normally, product specific, and tend to be an expensive customization. Furthermore, various commonly used lawn mower attachments such as rear mounted grass-catching bags have heretofore had an inhibitory influence on the development of any pull behind type grooming device since the bags or containers which are utilized to receive the grass clippings typically would interfere with the function of a towed grooming device, and vice-versa.

A lawn grooming device for utilization with lawn tractors of conventional design and which avoids the shortcomings in the earlier devices employed heretofore, is the subject matter of the present invention.

### SUMMARY OF THE INVENTION

A first aspect of the present invention relates to a lawn grooming device which includes a tow bar releasably coupled to a self-propelled overland vehicle; a drawbar support frame mounted on the tow bar; a first weighted earth engaging roller assembly affixed to the drawbar support frame; a drawbar mounted on the drawbar support frame, and which further is adjustable as to length, and the first weighted earth engaging roller assembly is mounted between the drawbar support frame and the drawbar; a coupling mounted on the drawbar and which is resiliently moveable in either the horizontal or vertical directions; and a second weighted earth engaging roller assembly mounted on the coupling and disposed in trailing relation relative to the first weighted earth engaging roller assembly.

A second aspect of the present invention relates to a lawn grooming device which includes a tow bar having a first end which releasably engages a rear hitch mounted on a rear end of a lawn tractor, and an opposite second end, and wherein a handle is mounted on the first end of the tow bar, and further has laterally disposed portions which operate to engage the rear end of the lawn tractor so as to limit the angular orientation that the tow bar may be moved relative to the rear end of the lawn tractor; a drawbar support frame mounted on the second end of the tow bar and which has two spaced arms, each having a distal end, and wherein the distal ends are spaced a given distance apart, and wherein the respective arms are oriented in predetermined substantially parallel spaced relation laterally outwardly relative to the tow bar; a frame supporting member mounted on the distal end of each of the arms of the drawbar support frame; a first weighted earth engaging roller assembly mounted on the second end of the tow bar, and wherein the first weighted earth engaging roller assembly includes a frame having a leading and a trailing edge, and wherein the leading edge is mounted on the second end of the tow bar, and the frame further defines opposite ends, and a transversely disposed cavity located between the leading and trailing edges, and wherein an earth engaging roller is rotatably mounted in the transversely disposed cavity, and the frame support members are individually releasably affixed to the opposite ends of the frame; a drawbar which is releasably mounted on the distal ends of the arms of the drawbar support frame, and wherein the drawbar has opposite ends, and an internal cavity, and wherein a first and second adjustment member is received, at least in part, within the internal cavity of the drawbar, and individually extends longitudinally outwardly relative to the opposite ends of the drawbar, and wherein the first and second adjustment members each have a distal end which can be located at variable distances longitudinally outwardly relative to the opposite ends of the drawbar; a resilient coupler mounted on the distal end of the respective first and second adjustment members, and which can be rendered simultaneously resiliently moveable in both vertical and horizontal directions upon the application of force; and a second pair of earth engaging roller assemblies which are individually mounted on the respective resilient couplers, and which are further disposed laterally outwardly, and in trailing relationship relative to the first earth engaging roller assembly, and wherein the respective second pair of earth engaging roller assemblies are independently moveable in both the horizontal and vertical directions.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is an environmental, perspective view of a lawn grooming device in accordance with one aspect of the invention, and which is shown mounted on a lawn tractor of conventional design.

FIG. 2 is a side elevation view of the lawn grooming device of the present invention.

FIG. 3 is a rear elevation view of the lawn grooming device of the present invention.

FIG. 4 is a front elevation view of the lawn grooming device of the present invention.

FIG. 5 is a side elevation view of the present invention, and which is taken from a position opposite to that seen in FIG. 2.

FIG. 6 is a top, plan view of the lawn grooming device of the present invention, and wherein the alternate positions of component parts of the lawn grooming device are shown in phantom lines to show the function of same.

FIG. 7 is a bottom, plan view of the lawn grooming device of the present invention.

FIG. 8 is a perspective, exploded, side elevation view of the lawn grooming device of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

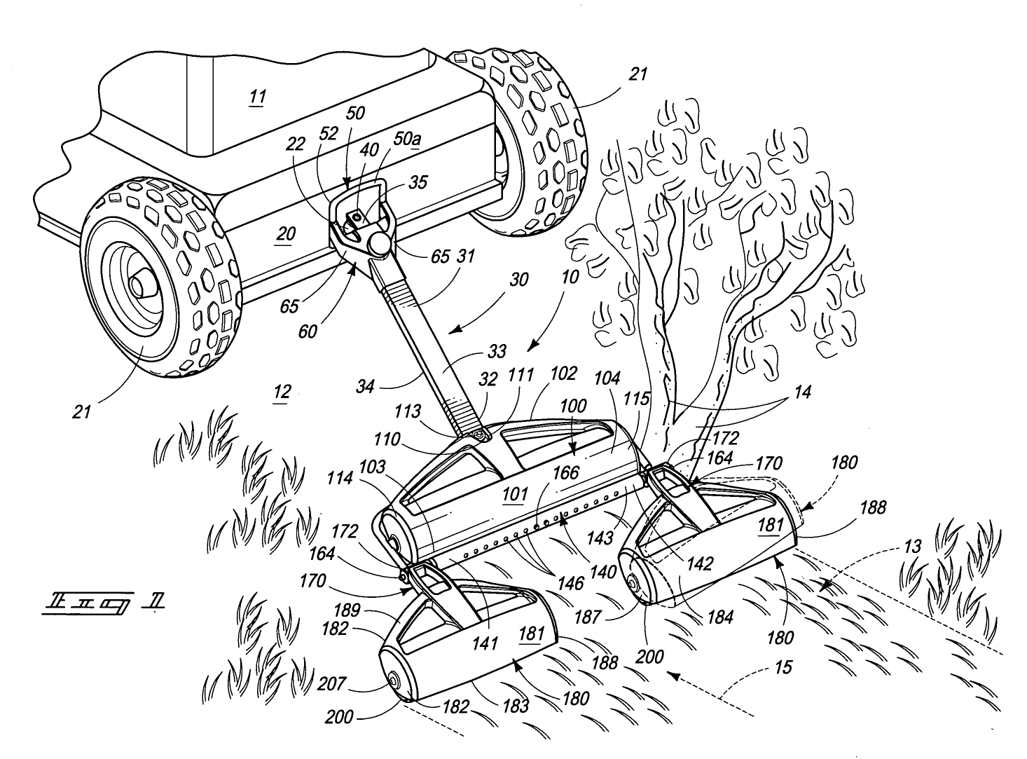

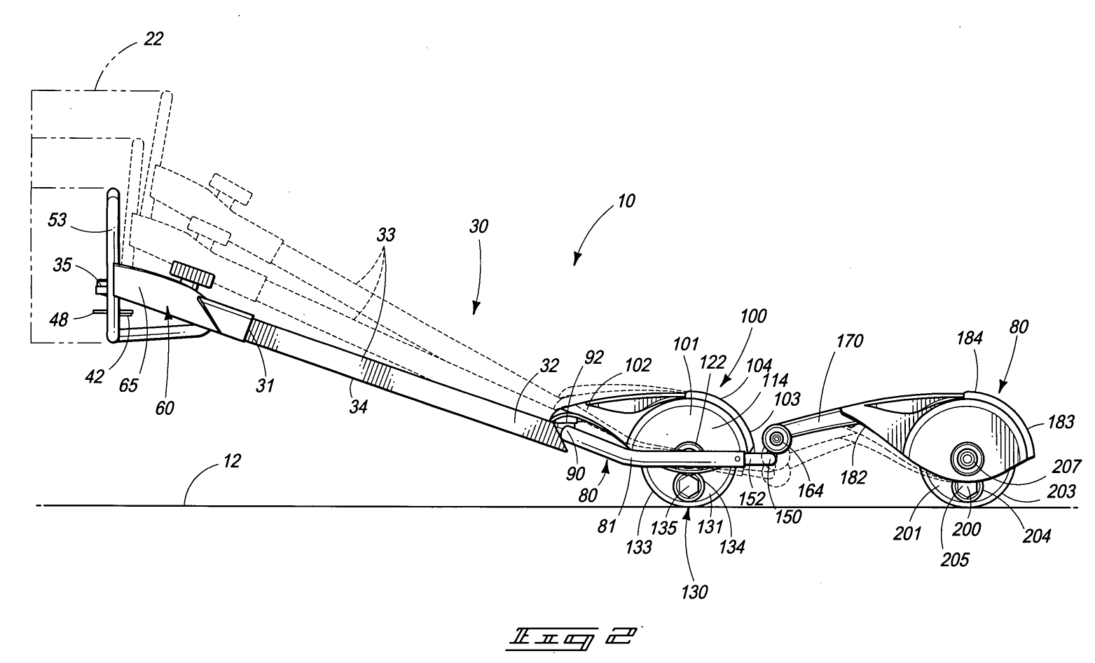

Referring now to FIG. 1, the present invention relates to a lawn grooming device which is generally indicated by the numeral 10, and which is further utilized with, and towed behind, in trailing relation, relative to a lawn tractor 11 of conventional design. As seen in FIG. 1, the lawn tractor 11 is operable for movement across the surface of the earth 12 so as to bend-over blades of grass 13 so as to provide an aesthetically appealing appearance to the grass surface. Further, as might be expected, the surface of the earth or grass surface 12/13 will typically include numerous obstacles such as a tree 14, which interrupt the continuous nature of the grass surface 13, and will inevitably have assorted variations in topography. The lawn grooming device 10 further is positioned in a towed trailing relationship behind the lawn tractor 11, as illustrated. The lawn tractor 11 is of conventional design, and has a rear end 20, and is further supported in rolling engagement relative to the surface of the earth 12 by earth engaging wheels 21. Still further, a rear hitch 22 of conventional design is mounted on the rear end 20 of the lawn tractor 11, and is employed to impart a pulling force to the lawn grooming device 10 so as to maintain it in an appropriate trailing relationship behind the lawn tractor 11. As best seen by reference to FIG. 2, the rear hitch 22 of the lawn tractor 11 may be located at variable distances of about 7 inches to about 12 inches above the surface of the earth 12 depending upon the design of the lawn tractor 10 being employed. While a lawn tractor 11 is illustrated as towing the lawn grooming device 10 of the present invention, it should be understood that other similar self-propelled overland vehicles may be substituted in place of the lawn tractor 11 and achieve the same benefits of the present invention. The lawn tractor or overland vehicle 11 is operable to propel the lawn grooming device 10 along a given path of travel 15 as indicated in FIG. 1.

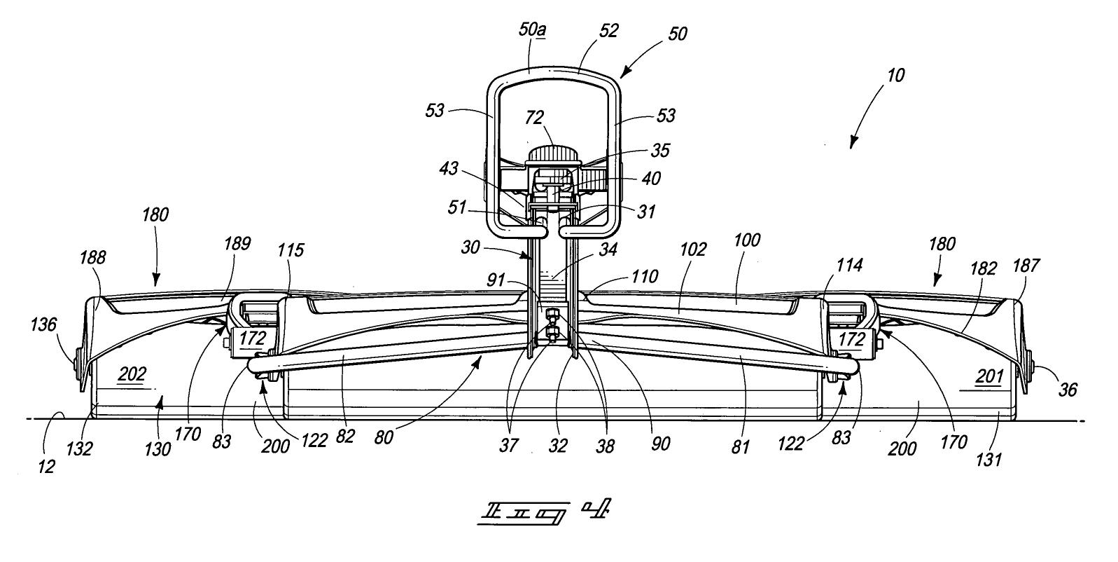

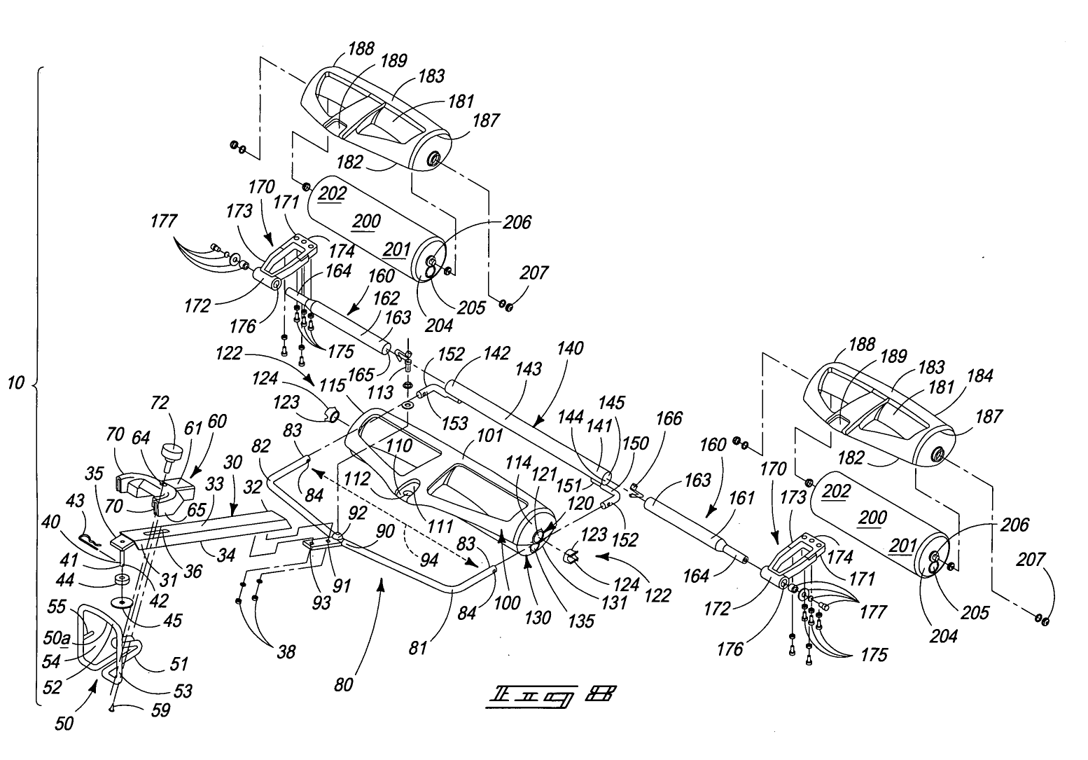

Referring more specifically now to FIG. 8, the lawn grooming device 10 of the present invention generally includes a tow bar which is indicated by the numeral 30, and which is releasably coupled to the self-propelled overland vehicle here depicted as the lawn tractor 11 (FIG. 1). The tow bar 30 has a first end 31, and an opposite second end 32. Still further, the tow bar 30 is defined by a top surface 33, and an opposite bottom surface 34. As illustrated, the tow bar is formed into a narrowly elongated, rectangular shape. Further, the tow bar has an angulated tongue portion 35 which extends generally, longitudinally outwardly relative to the first end 31. The angulated tongue 35, as seen in FIG. 2, permits the lawn grooming device 10 to be utilized on overland vehicles, such as variously designed lawn tractors 11, which have rear hitches 22 which may be positioned at variable distances from as low as about 7 inches, to about as high has 12 inches above the surface of the earth 12. Therefore, this arrangement permits the use of the lawn grooming device 10 on a variety of overland vehicles of different designs. Still further, in the arrangement as seen in the drawings, the tow bar 30 has a length dimension of generally about 20 inches, although other longer, and shorter tow bars are conceivable. Still further, formed near the first end 31, of the tow bar 30, is an elongated adjustment slot 36. The function of this elongated adjustment slot will be discussed in greater detail, hereinafter. Still further, extending normally downwardly from the bottom surface 34, and near the second end 32 of the tow bar 30 is a pair of threaded posts 37 (FIG. 4) which will facilitate the attachment of the drawbar support frame to the tow bar. The threaded posts 37 are operable to threadably matingly receive individual self-locking nuts 38. As seen in the drawings, and specifically the exploded view as seen in FIG. 8, an engagement or hitching post 40 extends normally downwardly relative to the angulated tongue 35, and is operable to be received within, or otherwise matingly couple with, the rear hitch 22 which is mounted on the lawn tractor 11. The engagement or hitching post 40 has a distal end 41 which has formed therein a cotter pin aperture 42. A cotter pin, safety pin or removable hitch pin 43 is operable to be received in the cotter pin aperture 42. This secures the engagement or hitching post 40 in a rotatable, force receiving relationship relative to the rear hitch 22 of the lawn tractor 11. Further, a first washer 44 is received about the engagement or hitching post 40. As should be understood, the angulated tongue 35 rests on this first washer 44 when it engages the rear hitch 22. The first washer provides a wear surface for the angulated tongue 35. Still further, a second washer 45 is received about the engagement or hitching post 40, and the cotter pin or safety pin 43 supports the second washer 45 on the engagement or hitching post 40. It should be understood that the removal of the engagement or hitching post from the rear hitch 22 would merely require the removal of the cotter pin 43, from the cotter pin aperture 42.

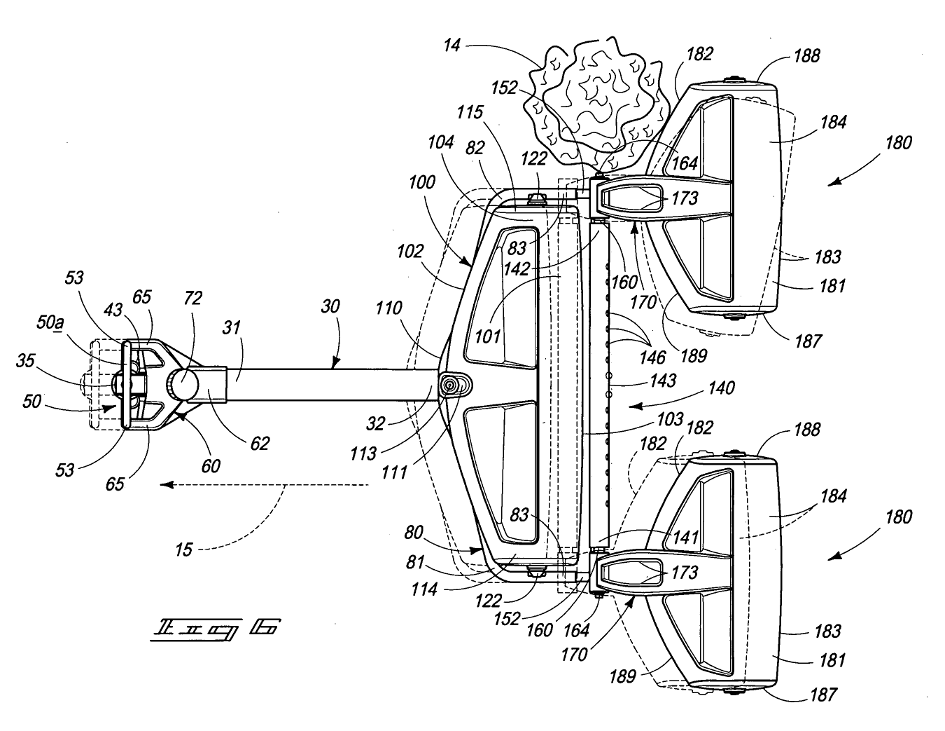

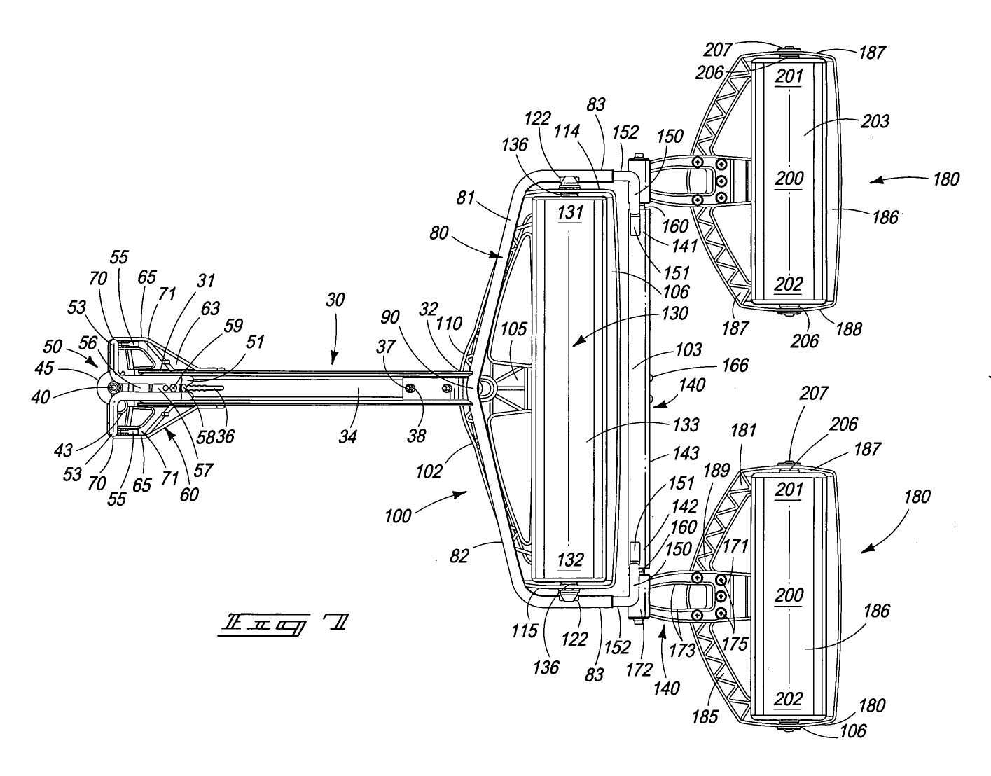

Still referring to FIG. 8, an adjustably positionable engagement frame 50 is mounted on the first end 31 of the tow bar 30 and has a portion 50A which operates as a handle or hand grip to assist an operator (not shown) in lifting the tow bar 30 onto the rear hitch 22. The engagement frame 50, as will be seen below, has portions 53 which extend laterally outwardly relative to the tow bar 30, and which individually operate to engage the lawn tractor 11 when the lawn tractor is turning or backing up so as to impede the jackknifing of the lawn grooming device 10 which is deployed in trailing relation behind the lawn tractor 11. Further, the longitudinal adjustment of the engagement frame 50 relative to the first end 31 of the tow bar 30 (FIG. 6) causes the selective angular orientation of the tow bar 30 relative to the rear end 20 of the lawn tractor. For example, should an operator desire that the lawn grooming device 10 not have a wide range of angular orientations where it may move relative to the rear end 20 of the lawn tractor 11, then in that event, the engagement frame 50 would be advanced and located longitudinally outwardly away from the first end 31. This would cause the lateral portions 53 of the engagement frame to engage the rear end 20 of the lawn tractor 11 sooner than if the engagement frame 50 was located closer to the first end 31 of the tow bar 30. The engagement frame 50, as seen in the drawings, includes a first end 51 which is secured to the first end 31 of the tow bar; and a second end 52, which operates, in part, as the handle 50A. Still further, the engagement frame 50 has laterally oriented portions 53 which are located laterally outwardly relative to the first end 31 of the tow bar 30, and which are operable to engage the rear end 20 of the tractor 11 so as to limit the angular orientation of the tow bar 30 relative to the rear end 20 of the tractor 11. As best seen by reference to FIG. 8, the portions 50A and 53 forms an aperture 54 through which an operator can grasp the second end 52 thereof. Engagement posts 55 are mounted on the laterally disposed portions, and extend outwardly relative thereto. Still further, the first end 51 defines a narrow slot 56 (FIG. 7) and further a rigid plate 57 is fastened in covering relation over the slot 56 and has formed therein a fastener aperture 58. The fastener aperture 58 is operable to receive a threaded fastener 59 which extends therethrough the elongated adjustment slot 36 (FIG. 8).

Mounted in mating relation on the top surface 33 of the tow bar 30 and located at the first end 31 thereof is an engagement frame clamping member which is generally indicated by the numeral 60. The engagement frame clamping member has a main body 61 which has a top surface 62 and an opposite bottom surface 63 (FIG. 7). An aperture 64 is formed therein (FIG. 8). Still further, the engagement frame clamping member 60 includes a pair of spaced apart engagement arms 65 which are operable to matingly receive, and engage the laterally oriented portions 53 of the engagement frame 50. As will be seen in FIG. 8, and in other views, the spaced apart engagement arms 65 each have a distal end 70 which matingly receives, at least in part, the respective laterally oriented portions 53. Further, the distal ends 70 define a cavity 71 (FIG. 7) extending longitudinally therein, and which is operable to matingly receive the respective engagement posts 55 which extend normally outwardly relative to the respective laterally oriented portions 53. When assembled in the manner as seen in FIG. 7, the threaded fastener 59 is engaged by a hand tightenable screw post which is generally indicated by the numeral 72, and which is received through the aperture 64, and which threadably mates with same. By threadably releasing the hand tightenable screw post, the engagement frame clamping member 60 and attached engagement frame 50 can slide or be moved longitudinally along the tow bar 30 (FIG. 6), and into various positions longitudinally outwardly relative thereto so as to provide an operator with a convenient means for adjusting the range of angular orientations that the tow bar 30 can assume, or be moved to, relative to the rear end 20 of the lawn tractor 11.

Mounted on the second end 32 of the tow bar 30 is a draw bar support frame which is generally indicated by the numeral 80 (FIG. 8). The draw bar support frame is generally defined by a first arm, and a second arm 81 and 82, respectively, which are spaced a given distance apart, and which each have a distal end 83. As best seen in FIG. 8, an aperture, here identified is formed through the distal ends 83 of the first and second arms 81 and 82, and is operable to receive a fastener that will be described, below. The first and second arms meet at an apex which is generally indicated by the numeral 90. Mounted at the apex and extending outwardly relative thereto is a tongue member 91 which has formed therein a pair of fastener apertures which are generally indicated by the numeral 93. This pair of fastener apertures have the same or similar spacing as compared to the spacing as provided between the threaded posts 37 (FIG. 4) which are affixed to the second end 32, of the tow bar 30, and which extends downwardly relative thereto. The respective threaded posts 37 are received through these fastener apertures 93, and the self-locking nuts 38 are operable to secure the tongue 91 onto the second end 32 of the tow bar 30. As best seen by reference to FIG. 8, a receiving station 94 is defined between the distal ends 83 of the first and second arms 81 and 82. The receiving station is operable to receive a first earth engaging roller assembly which is generally indicated by the numeral 100 and which is discussed in the paragraphs which follow.

The present invention 10 includes a first earth engaging roller assembly which is generally indicated by the numeral 100, and which is positioned within the receiving station 94 as defined between the first and second arms 81 and 82 of the draw bar support frame 80. The first earth engaging roller assembly 100 is defined, at least in part, by a frame or fender arrangement 101 which has a leading edge 102, and a trailing edge 103. Still further, the frame or fender 101 has a top or upwardly facing surface 104, and a bottom or downwardly facing surface 105 (FIG. 7) which defines a transversely disposed cavity 106. Still further, the top surface 104 is defined, in part, by an apex 110 which is positioned substantially midway along the length dimension of the top surface. Formed at the apex is a cavity 111. Further, an aperture 112 is formed in the cavity 111 and which is coaxially aligned relative to the threaded receiver 92 which is mounted on the apex 90 of the draw bar support frame 80. Further, a threaded fastener, and washer combination 113 (FIGS. 1 and 8) threadably mate with the threaded receiver 112 so as to secure the apex 110 of the frame or fender 101 to the frame 80. This, of course, secures the fender or frame 101 in an appropriate fixed orientation within the receiving station 94. Moreover, the fender or frame has a first end 114, and an opposite, second end 115 as illustrated best in FIG. 8.

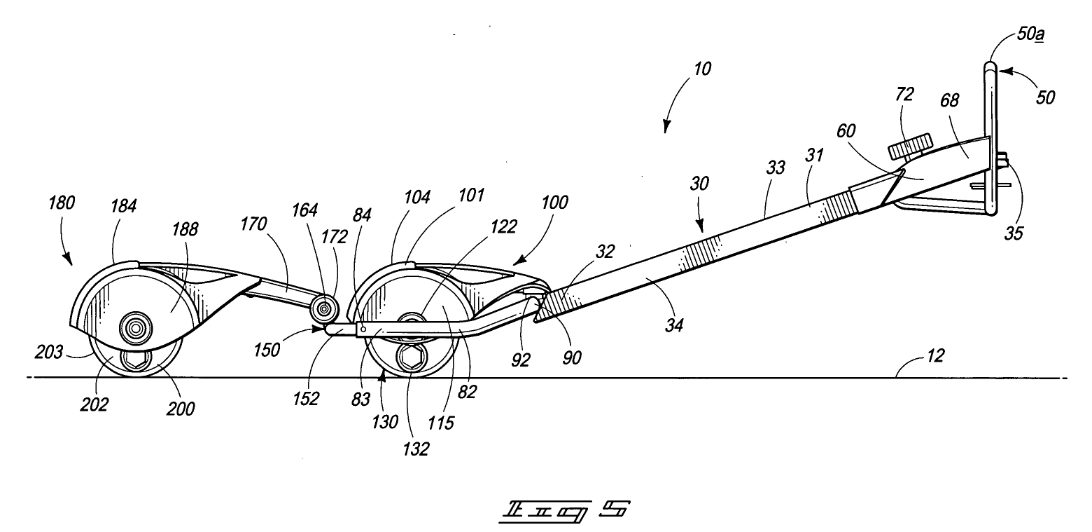

Referring again to the same figure, it will be seen that individual circular shaped cavities, here labeled by the numeral 120, are formed in the opposite first and second ends 114 and 115 of the frame or fender 101 of the first earth engaging roller assembly 100. These respective cavities 120 are aligned substantially along the longitudinal axis of the transversely disposed cavity 106. Further, there is an aperture formed substantially centrally of each of the cavities 120, and which are individually operable to matingly couple with the earth engaging roller, which will be disclosed below. Still further, individual frame support members which are generally indicated by the numeral 122, and which have a substantially circular main body 123 are dimensioned to be received, or supported in the manner of a friction-fit, within the respective cavities 122. The frame support members further have a semi-circular receiving member 124 mounted on the main body 123, and which matingly receive and cooperate with the respective distal ends 83, of the first and second arms 81 and 82 of the draw bar support frame 80. This frame support member 122 maintains the respective distal ends 83 in a substantially fixed spaced relationship relative to the surface of the earth 12 or grass 13 (FIGS. 2 and 5).

As best seen by reference to FIG. 7, a rotatable earth engaging roller 130 is received within the transversely disposed cavity 106 as defined by the bottom surface 105. The earth engaging roller 130 has a first end 131, and a second end 132. Further, the earth engaging roller is defined by a substantially circular, exterior facing surface 133 which engages the surface of the earth 12 so as to bend the blades of grass 13. Additionally, the earth engaging roller includes, at one end, a filling aperture 134 (FIG. 2), and a threaded plug 135 which is operable to selectively occlude the filling aperture 134. The earth engaging roller defines an internal cavity (not shown) which communicates with the filling aperture 134. As should be understood, a flowable substance having a significant mass such as sand, gravel, cement, water or other flowable material (not shown) is received through the filling aperture 134, and is received in the internal cavity of the earth engaging roller 130, and is further used to increase the mass of same so that it may achieve the benefits of the present invention, which include, among others, bending the blades of grass 13 over which it rolls, so as to achieve the aesthetically appealing appearance desired by the operator of the lawn tractor 11. The earth engaging roller 130 has individual axle members 136 (FIG. 7) extending longitudinally outwardly relative to the first and second ends 131 and 132 and which are substantially aligned with and received, at least in part, within the apertures 121 formed in the first and second ends 114 and 115, respectively of the fender or frame 101. When received in the apertures 121, the axle members render the earth engaging roller rotatable within the transversely disposed cavity 106.

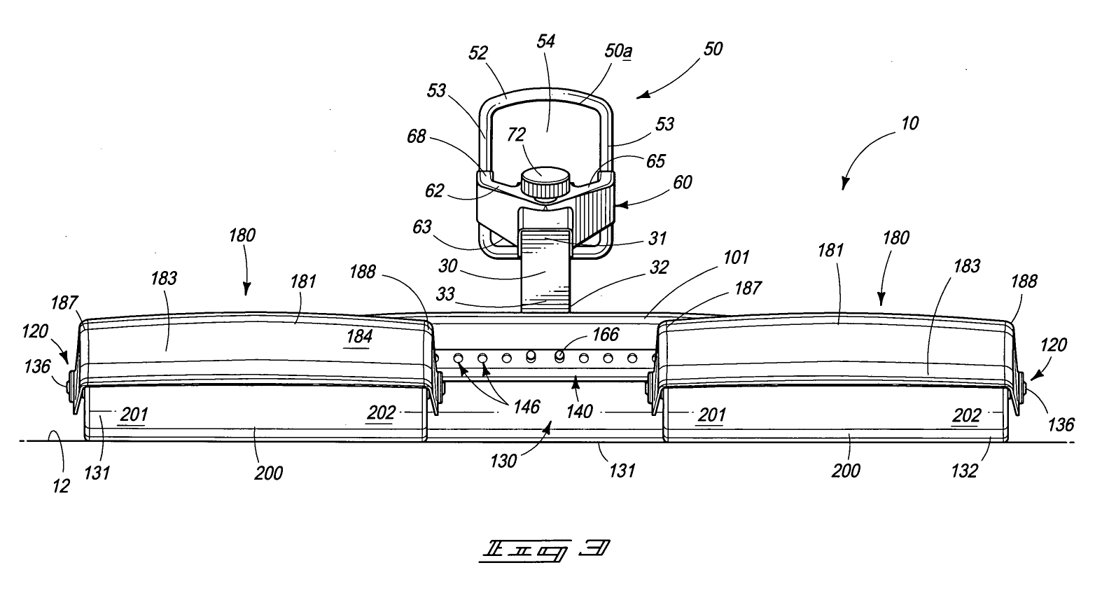

As seen in FIG. 8, and in many of the other views, a draw bar, which is generally indicated by the numeral 140, is provided, and which is releasably mounted on the distal ends 83, of the draw bar support frame 80. The draw bar 140 has opposite first and second ends 141 and 142, respectively, and is further defined by an outside facing surface 143, and an opposite inside facing surface 144. The inside facing surface defines a longitudinally extending cavity 145 (FIG. 8). As seen in the view of FIG. 6, the draw bar 140, has formed therein a plurality of apertures 146, and which extend generally along the length of the draw bar 140, and between the first and second ends 141 and 142. The respective apertures 146 are spaced a predetermined distance apart. These apertures are operable to position a pair of second, earth engaging roller assemblies at various locations laterally, outwardly, relative to the first engaging roller assembly 130. The second earth engaging roller assemblies will be discussed in greater detail, hereinafter. Further, as seen in FIGS. 7 and 8, the draw bar 140 includes draw bar inserts or engagement members 150 which have a first end 151, which is affixed by welding or the like, to the outside facing surface 143, near the opposite first and second ends 141 and 142, respectively. These draw bar inserts or engagement members are generally right angularly shaped rigid structures which have a second end 152 which is sized so as to be individually telescopingly received within the respective distal ends 83 of the draw bar support frame 80. Further, as seen in FIG. 8, an aperture or passageway 153 is formed in the second end of each of the respective draw bar inserts. When this aperture is properly oriented relative to the distal ends 83, the aperture 84, and the aperture 153 are coaxially aligned, and are operable to receive a pin or other fastener therethrough thereby releasably securing the draw bar 140 on the draw bar support frame 80, and to the frame or fender arrangement 101. As such, the draw bar 140 is positioned in a predetermined, spaced relationship relative to the surface of the earth 12 (FIG. 3).

Received within, and extending a given distance longitudinally outwardly relative to the opposite ends 141 and 142 of the draw bar 140 are individual adjustment members which are generally indicated by the numeral 160. The respective adjustment members include first and second adjustment members 161 and 162, respectfully. Further, each adjustment member has a first end 163 which is sized so as to be telescopingly, coaxially received within the opposite ends 141 and 142 of the draw bar 140 and within the longitudinally disposed cavity 145 as seen in FIG. 8. Each of the first and second adjustment members 161 and 162 also has an opposite, second or distal end 164 which is illustrated in FIG. 8. This second end has a reduced outside diametral dimension portion relative to the first end 163. The second end 164 of each of the adjustment members are operable to be matingly received, and oriented in telescoping relation relative to a resilient coupler which will be discussed in greater detail in the paragraphs which follow. Further, the respective adjustment members 161 and 162 each define a longitudinally disposed cavity 165. It will be understood from the drawings that an aperture (not shown) is formed near the first end 163 of each of the adjustment members, and further, a spring biased detent 166 (FIGS. 3 and 8) is received within the longitudinally disposed cavity 165, and located at or near the first end 163. The spring biased detent extends outwardly, at least in part, through the aperture (not shown) formed in the first end 163 so that it may be simultaneously received in mating relation relative to one of the plurality of apertures 146 which are formed longitudinally along the outside surface 143 of the draw bar 140 (FIG. 3). By the selective depression of the spring biased detent that is seated or located within one of the plurality of apertures 146, the respective first and second adjustment members 160 may be selectively oriented at given distances longitudinally, outwardly relative to the draw bar 140 so as to position the second or distal ends 164 in given locations which are laterally outwardly disposed and in trailing relation relative to the first earth engaging roller assembly 100. This provides a convenient means whereby the operator of the tractor 11 may allow for the selective adjustment of a second earth engaging roller assembly, as will be discussed below, in locations laterally outwardly relative to the first earth engaging roller assembly 100.

As best seen in FIG. 8, a resilient coupler which is generally indicated by the numeral 170 is mounted on the second, or distal end 164 of the respective first and second adjustment members 161 and 162, respectively. The resilient coupler is fabricated from a material which permits the resilient coupler to be rendered simultaneously resiliently moveable in both vertical, and horizontal directions upon the application of physical force to the coupler. This physical force is provided when the second earth engaging roller assembly, as will be discussed hereinafter, encounters obstacles or moves across the changing topography of the surface of the earth 12 (FIG. 1). This resilient coupler 170 also allows the second earth engaging roller assemblies, which will be discussed in greater detail below, to remain in contact with the surface of the earth 12 as the overland vehicle or tractor 11 moves across the surface of the earth 12. Further, the resilient coupler 170 permits the individual second earth engaging roller assemblies to move horizontally and vertically in different directions so that if, for example, one of the second earth engaging rollers assemblies strikes an obstacle such as a tree 14 (FIG. 6) while it is being towed across the surface of the earth 12, then the earth engaging roller assembly which strikes the tree may move out of the way of the obstacle and around it and thus avoid any damage either to that assembly or to other components of the invention 10. This movement is shown in phantom lines. In the arrangement as seen in FIG. 8, and in the other drawings, the resilient coupler 170 has a first end 171, and an opposite second end 172 which are coupled together by spaced apart resilient arms which are generally indicated by the numeral 173. The resilient arms allow the resilient coupler to flex in both horizontal and vertical directions substantially simultaneously so as to accommodate the use of the present invention 10 on terrain having variable topography. As seen in FIG. 8, a plurality of apertures 174 are formed in the first end 171, and are operable to receive various fasteners 175 therethrough. These fasteners operate to secure the first end 171 of the resilient coupler on a second earth engaging roller assembly as will be described in the paragraphs which follow. Further, as seen in FIG. 8, a longitudinally disposed channel or passageway 176 is formed in the second end 172. This longitudinally disposed channel or passageway is substantially cylindrically shaped, and has an inside diametral dimension which is slightly larger than the outside diametral dimension of the second or distal ends 164 of the respective first and second adjustment members 161 and 162, respectively. As seen in that drawing, the second or distal ends 164 of the respective first and second adjustment members 161, 162 are individually telescopingly received within this longitudinally disposed channel 176. Still further, a fastener/washer/threaded insert combination 177 operate together to thereby rotatably secure the resilient coupler 170 on the second end 164 of the respective adjustment members 160.

As seen in FIG. 1 and following, the present invention 10 includes a second pair of earth engaging roller assemblies 180 which each have a length dimension which is less than about 64% of the length dimension of the first engaging roller assembly 100. These second earth engaging roller assemblies are each defined, in part, by a frame or fender 181 which has a forward or leading edge 182, and a trailing edge 183. Still further, the frame or fender has a top surface 184, and a bottom surface 185 (FIG. 7) which defines a transversely disposed cavity 186. Still further, the frame or fender 181 has a first end 187, and an opposite second end 188. Additionally, as seen in the drawings, the frame or fender has an apex 189 which is disposed substantially midway between the opposite first and second ends 187 and 188. Further, the resilient coupler 170 is fastened at the apex 189, and onto the bottom surface 185 by means of the fasteners 175 as seen most clearly by reference to FIG. 7. The second pair of earth engaging roller assemblies 180 each include a rotatable, earth engaging roller 200 which is rotatably mounted within the transversely disposed cavity 186. Each of these earth engaging rollers have a first end 201, and an opposite second end 202. The earth engaging rollers are defined further by an exterior facing surface 203 (FIG. 2) which engages the surface of the earth 12. Still further, a filling aperture 204 is formed in one of the ends of the earth engaging roller and a threaded plug 205 is operable to threadably mate with same. Additionally, the earth engaging roller defines a continuous internal cavity (not shown), but which communicates with the filling aperture 204. As will be seen, the axle members 206 (FIG. 1) extend longitudinally outwardly from the first and second ends 201 and 202 thereof, and are operable to be rotatably supported on the opposite first and second ends 187 and 188 of the frame or fender 181. As earlier discussed with respect to the first earth engaging roller assembly 100, a flowable substance such as water, concrete, sand, leaded pellets or any other dense granular material may be received through the filling aperture 204, and into the internal cavity thereby increasing the mass of the earth engaging roller so that it may accomplish its purpose of rolling across the surface of the earth 12, and bending blades of grass 13 in order to achieve an aesthetically pleasing appearance for the lawn 13 as the lawn tractor 11 moves across the surface of the earth 12. As seen in FIG. 8, the individual earth engaging rollers 200 include axel members 206 which extend through the fender or frame 181, and a fastener 207 (FIG. 8) is operable to engage the axel member thereby securing the earth engaging roller 200 in a given rotatable orientation within the transversely disposed cavity 186. As will be recognized from the drawings, the second pair of earth engaging roller assemblies 180 are individually mounted on the respective resilient couplers 170, and are further disposed laterally outwardly, and in trailing relationship relative to the first earth engaging roller assembly 100. The respective second pair of earth engaging roller assemblies 180 are independently moveable in both the horizontal and vertical directions by means of the resilient coupler 170 which was earlier described.

Therefore, the second pair of earth engaging rollers 180 may be disposed at given locations laterally outwardly, and in overlapping rolling relation relative to the first earth engaging roller 100, and by means of the resilient coupler 170 may strike or otherwise come into contact with obstacles, such as a tree, and by means of the resilient coupler 170 may move out of contact with or around the obstacle and thereafter assume a normal trailing orientation relative to the first earth engaging roller assembly 100.

### Operation

The operation of the described embodiment of the present invention is believed to be readily apparent and is briefly summarized at this point.

In a first aspect of the present invention, a lawn grooming device 10 is shown, and described, and which includes a tow bar 30 which is releasably coupled to a self-propelled overland vehicle 11; and a drawbar support frame 80 is mounted on the tow bar 30. The invention further includes a first, weighted, earth engaging roller assembly 100 which is affixed to the drawbar support frame 80; and a drawbar 140 is mounted on the drawbar support frame 80, and which further is adjustable as to length, and the first weighted earth engaging roller assembly 100 is mounted between the drawbar support frame 80 and the drawbar 140. Still further, in this form of the invention, a coupling 170 is provided which is mounted on the drawbar 140 and which is resiliently moveable in either the horizontal or vertical directions. Still further, this invention includes a second weighted earth engaging roller assembly 180 which is mounted on the coupling 170, and further disposed in trailing relation relative to the first weighted earth engaging roller assembly 100.

In the present invention, the self-propelled overland vehicle is a lawn tractor 11, which has rear hitch 22, and the tow bar 30 has a first end 31 which releasably engages the rear hitch 22. An engagement frame 50 is mounted on the first end 31 of the tow bar 30, and has portions 53 which extend laterally outwardly relative thereto, and which operate as a handle 50A to assist an operator in lifting the tow bar 30. The laterally extending portions 53 engage the lawn tractor 11 when the lawn tractor is turning, or backing up so as to impede the jackknifing of the lawn grooming device 10 which is deployed in trailing relation behind the lawn tractor 11. In the form of the invention as described, the tow bar 30 has a first end 31 which is releasably pivotally mounted on the rear hitch 22 of the self-propelled overland vehicle 11, and an opposite, second end 32, which is rigidly affixed to the first weighted earth engaging roller assembly 100. The length of the tow bar 30 is selected so that the first end 31 of the tow bar may releasably pivotally attach to the rear hitch 22 of conventional overland vehicles 11 regardless of the height of the rear hitch 22 is above a surface 12 which supports the self-propelled overland vehicle. In one form of the invention 10, which can be effectively utilized on conventional lawn tractors 11, the length of the tow bar is at least about 20 inches, and the height of the rear hitch 22 on the self-propelled overland vehicle 11 is about 7 inches to about 12 inches above the surface 12 supporting the self-propelled overland vehicle 11.

In the form of the invention 10, as shown in the drawings, the drawbar support frame 80 includes a pair of spaced arms 81 and 82 having distal ends 83, and which are releasably affixed to the drawbar 140, and which define a receiving station 94 therebetween. The first weighted earth engaging roller assembly 100 is mounted between, and releasably fixed to the respective distal ends 83 of the spaced arms 81 and 82, and within the receiving station 94. The first weighted earth engaging roller assembly 100 is further rigidly affixed to the second end 32 of the tow bar 30. In the arrangement as seen in the drawings, the first and second weighted earth engaging roller assemblies 100 and 180, respectively each include a frame 101 and 181 defining a transverse cavity 106, 186 and which has a given length dimension; an earth engaging roller 130, 200 having an outwardly facing surface 133, 203 and each defining an internal cavity is rotatably supported in the respective frames 101, 181. In the arrangement as seen in the drawings, the respective earth engaging rollers as described above, further defines an aperture 134, 204 which allows access to the internal cavity of same, and the respective earth engaging rollers are individually rotatably mounted in the cavities 106, 185 of the respective frames 101, 181. Still further, in this form of the invention, a flowable substance is delivered into the internal cavity of the respective earth engaging rollers 130, 200 through the apertures 134, 204. This flowable substance significantly increases the mass of the respective earth engaging rollers so as to effectively bend blades of grass 13 over when the earth engaging roller assembly 100, 180 is moved across the surface of the earth 12. In the arrangement as seen in the drawings, the second earth engaging roller assembly 180 has a length dimension which is equal to or less than the length of the first earth engaging roller assembly 100. Still further, as seen in the drawings, the second earth engaging roller 180 includes a pair of earth engaging roller assemblies which are disposed in adjustably spaced, laterally outwardly disposed relation one relative to the other, and in individual laterally outwardly oriented, and trailing relationship behind the first earth engaging roller assembly 100.

In the arrangement as seen the drawings, the lawn grooming device 10 includes a drawbar 140 which defines an internal cavity 145, and further includes an adjustment member 160, having a distal end 164, and which is coaxially received within the internal cavity 145 of the drawbar 140, and which can be selectively secured therein so as to locate or otherwise position the distal end 164 of the adjustment member 160 at various locations which are oriented laterally outwardly relative to the first earth engaging roller assembly 100. The coupling 170 is mounted on the distal end of the adjustment member 160. In the arrangement as seen the drawings, and in one form of the invention, the drawbar 140 includes a second adjustment member 160, and wherein the pair of adjustment members extend longitudinally outwardly relative to the opposite ends of the drawbar 140, and which are individually operable to position a second pair of earth engaging roller assemblies 180 laterally outwardly, and in trailing relation relative to the first earth engaging roller assembly 100. In the arrangement as seen the drawings, the coupling 170 permits or readily facilitates the resilient movement of the second weighted earth engaging roller assembly 180 in a range of travel of greater than about 45 degrees in both the horizontal and vertical directions. Still further, In the arrangement as seen the drawings, the drawbar 140 can be releasably detached from the drawbar support frame 80. The coupler 170 is employed to bias or otherwise maintain the second weighted earth engaging roller assembly 180 in contact with the surface of the earth 12.

In another aspect of the invention, a lawn grooming device 10 is disclosed and which includes a tow bar 30 having a first end 31 which releasably engages a rear hitch 22, and which is mounted on a rear end 20 of a lawn tractor 11. Still further, the tow bar has an opposite second end 32, and wherein a handle 50A is mounted on the first end 31 of the tow bar, and further has laterally disposed portions 53 which operate to engage the rear end 20 of the lawn tractor 11 to limit the angular orientation that the tow bar 30 may be moved relative to the rear end of the lawn tractor 11. In this form of the invention, a drawbar support frame 80 is mounted on the second end 32 of the tow bar 30 and which has two spaced arms 81, 82, each having a distal end 83, and wherein the distal ends are spaced a given distance apart, and wherein the respective arms 81, 82 are oriented in predetermined substantially parallel spaced relation laterally outwardly relative to the tow bar 30. In this form of the invention, a frame supporting member 122 is provided, and mounted on the distal end 83 of each of the arms 81 and 82, of the drawbar support frame 80. A first weighted earth engaging roller assembly 100 is provided and mounted on the second end 32 of the tow bar 30, and wherein the first weighted earth engaging roller assembly includes a frame 101 having a leading edge 102, and a trailing 103 edge, and wherein the leading edge 102 is mounted on the second end 32 of the tow bar 30. The frame 101 further defines opposite ends 114 and 115, and a transversely disposed cavity 106 located between the leading and trailing edges. An earth engaging roller 130 is rotatably mounted in the transversely disposed cavity 106, and the frame support members 122 are individually releasably affixed to the opposite ends of the frame 101. In the arrangement as seen the drawings, a drawbar 140 is provided, and which is releasably mounted on the distal ends 83 of the arms 81 and 82 of the drawbar support frame 80. The drawbar 140 has opposite ends 141 and 142, and an internal cavity 145. Opposite, first and second adjustment members 160 are received, at least in part, within the internal cavity 145 of the drawbar 140. The respective adjustment members 160 individually extend longitudinally outwardly and in opposite directions relative to the opposite ends of the drawbar 140. The first and second adjustment members 160 each have a distal end 164 which can be located at variable distances longitudinally outwardly relative to the opposite ends of the draw bar 160. In this form of the invention, a resilient coupler 170 is provided and mounted on the distal end 164 of the respective first and second adjustment members 160 and which can be rendered simultaneously resiliently moveable in both vertical and horizontal directions upon the application of force. In the arrangement as seen in the drawings, a second pair of earth engaging roller assemblies 180 are individually mounted on the respective resilient couplers 170, and are further disposed laterally outwardly, and in trailing relationship relative to the first earth engaging roller assembly 100. The respective second pair of earth engaging roller assemblies 180 are independently moveable, in both the horizontal and vertical directions. In the arrangement as seen the drawings, the drawbar 140 has a plurality of apertures 146 formed therein, and which extend along the length thereof, and a spring biased detent 166 is mounted within the respective first and second adjustment members 160. The selective positioning and engagement of the respective spring biased detents in selected ones of the plurality of apertures 146 formed in the drawbar 140 causes each of the distal ends 164 of the respective first and second adjustment members 160 to be located at predetermined locations which are located longitudinally outwardly relative to the opposite ends 141 and 142, respectively of the drawbar 140. In the arrangement as seen the drawings, the second pair of earth engaging roller assemblies 180 each have a length dimension which is less than about 64% of the length dimension of the first earth engaging roller assembly 100. Still further, as seen in FIG. 1, the earth engaging rollers 130 and 200 of the respective first and second earth engaging roller assemblies 100 and 180 are disposed in an overlapping rolling relationship relative to the surface of the earth 12 over which the lawn tractor 11 travels. In the arrangement as seen the drawings, the overlapping rolling relationship of the first and second earth engaging rollers 130 and 200, respectively, has a width dimension of about 38 to about 52 inches. Still further, as understood from the drawings (FIG. 6), the handle 50A is longitudinally moveable along the tow bar 30 so as to adjust the range of the angular orientation of tow bar 30 relative to the rear end of the lawn tractor 11.

Therefore, it will be seen that the present invention 10 provides a convenient means whereby an operator may effectively groom lawn areas of various sizes to achieve any number of desired aesthetically appealing appearances.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A lawn grooming device, comprising:
a tow bar releasably coupled to a self-propelled overland vehicle;
a drawbar support frame mounted on the tow bar;
a first weighted earth engaging roller assembly affixed to the drawbar support frame;
a drawbar mounted on the drawbar support frame, and which further is adjustable as to length, and the first weighted earth engaging roller assembly is mounted between the drawbar support frame and the drawbar;
a coupling mounted on the drawbar and which is resiliently moveable in either the horizontal or vertical directions; and
a second weighted earth engaging roller assembly mounted on the coupling and disposed in trailing relation relative to the first weighted earth engaging roller assembly.

2. A lawn grooming device as claimed in claim 1, and wherein the self-propelled overland vehicle is a lawn tractor, which has rear hitch, and the tow bar has a first end which releasably engages the rear hitch, and wherein an engagement frame is mounted on the first end of the tow bar, and extends laterally outwardly relative thereto and which operates as a handle to assist an operator in lifting the tow bar, and which further engages the lawn tractor when the lawn tractor is turning, or backing up so as to impede the jackknifing of the lawn grooming device which is deployed in trailing relation behind the lawn tractor.

3. A lawn grooming device as claimed in claim 1, and wherein the self-propelled vehicle has a rear hitch for towing the lawn grooming device in trailing relation relative thereto, and the tow bar has a first end which is releasably pivotally mounted on the rear hitch of the self-propelled overland vehicle, and an opposite, second end, which is rigidly affixed to the first weighted earth engaging roller assembly, and wherein the length of the tow bar is selected so that the first end of the tow bar may releasably pivotally attach to the rear hitch of the overland vehicle regardless of the height of the rear hitch above a surface supporting the self-propelled overland vehicle.

4. A lawn grooming device as claimed in claim 3, and wherein the length of the tow bar is at least about 20 inches, and the height of the rear hitch on the self-propelled overland vehicle is about 7 inches to about 12 inches above the surface supporting the self-propelled overland vehicle.

5. A lawn grooming device as claimed in claim 1, and wherein the tow bar has a first end which is releasably pivotally mounted on the self-propelled overland vehicle, and an opposite, second end, and wherein the drawbar support frame includes a pair of spaced arms having distal ends, and which are releasably affixed to the drawbar, and which define a receiving station therebetween, and wherein the first weighted earth engaging roller assembly is mounted between, and releasably fixed to the respective distal ends of the spaced arms, and within the receiving station, and wherein the first weighted earth engaging roller assembly is further rigidly affixed to the second end of the tow bar.

6. A lawn grooming device as claimed in claim 1, and wherein each of the first and second weighted earth engaging roller assemblies further comprise:
a frame defining a cavity and which has a given length dimension;
an earth engaging roller having an outwardly facing surface defining an internal cavity, and wherein the earth engaging roller further defines an aperture which allows access to the internal cavity, of the earth engaging roller, and wherein the earth engaging roller is rotatably mounted in the cavity of the frame; and
a flowable substance delivered to the internal cavity of the earth engaging roller through the aperture, and which increases the mass of the earth engaging roller to effectively bend blades of grass over when the earth engaging roller assembly is moved across the surface of the earth.

7. A lawn grooming device as claimed in claim 6, and wherein the second earth engaging roller assembly has a length dimension which is equal to or less than the length of the first earth engaging roller assembly.

8. A lawn grooming device as claimed in claim 6, and wherein the second earth engaging roller includes a pair of earth engaging roller assemblies which are disposed in adjustably spaced laterally outwardly disposed relation one relative to the other, and in individual laterally outwardly oriented, and trailing relationship behind the first earth engaging roller assembly.

9. A lawn grooming device as claimed in claim 1, and wherein the drawbar defines an internal cavity, and further includes an adjustment member, having a distal end, and which is coaxially received within the internal cavity of the drawbar, and which can be secured therein so as to locate the distal end of the adjustment member at various locations which are oriented laterally outwardly relative to the first earth engaging roller, and wherein the coupling is mounted on the distal end of the adjustment member.

10. A lawn grooming device as claimed in claim 9, and wherein the drawbar has opposite ends, and further includes a second adjustment member having a distal end, and which is coaxially received and selectively releasably affixed within the internal cavity of the drawbar, and wherein the respective adjustment members extend longitudinally outwardly relative to the opposite ends of the drawbar, and wherein the second earth engaging roller assembly includes a pair of earth engaging roller assemblies which are individually affixed on the respective distal ends of the individual adjustment members, and located laterally outwardly and in trailing relation behind the first earth engaging roller assembly.

11. A lawn grooming device as claimed in claim 1, and wherein the first weighted earth engaging roller assembly comprises:
a frame which defines an internal cavity, and wherein the frame has opposite ends and further defines, in part, a fender;
an earth engaging roller rotatably mounted in the internal cavity of the frame, and which is spaced from, and covered, at least in part, by the fender; and
individual support members are mounted on the fender, and located at the opposite ends of the frame defining the first weighted earth engaging roller assembly, and wherein the respective support members releasably matingly couple with the drawbar support frame, and wherein the drawbar support frame is secured to the fender.

12. A lawn grooming device as claimed in claim 1, and wherein the coupling permits resilient movement of the second weighted earth engaging roller assembly in a range of travel of greater than about 45 degrees in both the horizontal and vertical directions.

13. A lawn grooming device as claimed in claim 1, and wherein the drawbar can be releasably detached from the drawbar support frame.

14. A lawn grooming device, comprising:
a tow bar having a first end which releasably engages a rear hitch mounted on a rear end of a lawn tractor, and an opposite second end, and wherein a handle is mounted on the first end of the tow bar, and further has laterally disposed portions which operate to engage the rear end of the lawn tractor to limit the angular orientation that the tow bar may be moved relative to the rear end of the lawn tractor;
a drawbar support frame mounted on the second end of the tow bar and which has two spaced arms, each having a distal end, and wherein the distal ends are spaced a given distance apart, and wherein the respective arms are oriented in predetermined substantially parallel spaced relation laterally outwardly relative to the tow bar;
a frame supporting member mounted on the distal end of each of the arms of the drawbar support frame;
a first weighted earth engaging roller assembly mounted on the second end of the tow bar, and wherein the first weighted earth engaging roller assembly includes a frame having a leading and a trailing edge, and wherein the leading edge is mounted on the second end of the tow bar, and the frame further defines opposite ends, and a transversely disposed cavity located between the leading and trailing edges, and wherein an earth engaging roller is rotatably mounted in the transversely disposed cavity, and the frame support members are individually releasably affixed to the opposite ends of the frame;
a drawbar which is releasably mounted on the distal ends of the arms of the drawbar support frame, and wherein the drawbar has opposite ends and an internal cavity, and wherein a first and second adjustment member is received, at least in part, within the internal cavity of the drawbar, and individually extends longitudinally outwardly relative to the opposite ends of the drawbar, and wherein the first and second adjustment members each have a distal end which can be located at variable distances longitudinally outwardly relative to the opposite ends of the drawbar;
a resilient coupler mounted on the distal end of the respective first and second adjustment members, and which can be rendered simultaneously resiliently moveable in both vertical and horizontal directions upon the application of force; and
a second pair of earth engaging roller assemblies which are individually mounted on the respective resilient couplers, and which are further disposed laterally outwardly, and in trailing relationship relative to the first earth engaging roller assembly, and wherein the respective second pair of earth engaging roller assemblies are independently moveable in both the horizontal and vertical directions.

15. A lawn grooming device as claimed in claim 14, and wherein the drawbar has a plurality of apertures formed therein and which extend along the length thereof, and a spring biased detent is mounted on the respective first and second adjustment members, and wherein the selective positioning and engagement of the respective spring biased detents in selected ones of the plurality of apertures formed in the drawbar causes each of the distal ends of the respective first and second adjustment members to be located at predetermined locations which are located longitudinally outwardly relative to the opposite ends of the drawbar.

16. A lawn grooming device as claimed in claim 14, and wherein the second pair of earth engaging roller assemblies each have a length dimension which is less than about 64% of a length dimension of the first earth engaging roller assembly.

17. A lawn grooming device as claimed in claim 14, and wherein each of the first and second earth engaging roller assemblies each have an earth engaging roller which defines an internal cavity and which is operable to be filled with a flowable substance which increases the mass of the respective earth engaging rollers.

18. A lawn grooming device as claimed in claim 17, and wherein the earth engaging rollers of the respective first and second earth engaging roller assemblies are disposed in an overlapping rolling relationship relative to the surface of the earth over which the lawn tractor travels.

19. A lawn grooming device as claimed in 18, and wherein the overlapping rolling relationship of the first and second earth engaging rollers has a width dimension of about 38 to about 52 inches.

20. A lawn grooming device as claimed in 18, and wherein the handle is longitudinally moveable along the tow bar so as to adjust the range of the angular orientation of tow bar relative to the rear end of the lawn tractor.
